(19) United States
(12) Patent Application Publication
(10) Pub. No.: US 2012/0258263 A1
(43) Pub. Date: Oct. 11, 2012

(54) CELLULOSE ACYLATE FILM, POLARIZING PLATE USING THE SAME AND LIQUID CRYSTAL DISPLAY DEVICE

(75) Inventors: Akio TAMURA, Minami-ashigara-shi (JP); Kengo ASAI, Minami-ashigara-shi (JP)

(73) Assignee: FUJIFILM CORPORATION, Tokyo (JP)

(21) Appl. No.: 13/442,465

(22) Filed: Apr. 9, 2012

(30) Foreign Application Priority Data
Apr. 11, 2011 (JP) 2011-087571
Apr. 9, 2012 (JP) 2012-088762

(51) Int. Cl. C09K 19/52; G02B 5/30; C08L 1/12

(52) U.S. Cl. 428/1.33; 524/41; 359/483.01

(57) ABSTRACT

A cellulose acylate film containing cellulose acylate and a polymer, the polymer containing a repeating unit derived from a monomer represented by formula (1); a polarizing plate containing a polarizing element and two protective films disposed on both sides of the polarizing element, at least one of the two protective films being made of the cellulose acylate film described above; and a liquid crystal display device containing a liquid crystal cell and two polarizing plates disposed on both sides of the liquid crystal cell, at least one of the polarizing plates being made of the polarizing plate described above:

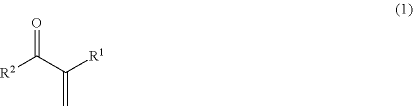

wherein R¹ represents a hydrogen atom or an aliphatic group having 1 to 4 carbon atoms, and R² represents an aliphatic group or an aromatic group.

### FIELD OF THE INVENTION

The present invention relates to a cellulose acylate film, a polarizing plate using the same and a liquid crystal display device.

### BACKGROUND OF THE INVENTION

A typical liquid crystal display device is equipped with two polarizing plates disposed in such a manner that a liquid crystal layer lies between them. The two polarizing plates are arranged so that the direction of polarization of the light is at right angles to one another. The two polarizing plates form a mechanism that controls ON/OFF (transmittance and blocking) of the light emitted from a backlight in accordance with a change of liquid-crystal molecular orientation by application of voltage. As for such polarizing plate, widely used are those having such a configuration that a polarizing element using polyvinyl alcohol (PVA) and iodine is sandwiched with polarizing plate protective films such as a cellulose acylate film. Especially, a cellulose acylate film is favorably used for a polarizing plate protective film because of its excellent transparency and small haze.

Meanwhile, recently, inclination for large-size-screen, enhancement in the quality of image, and price reduction of the liquid crystal display device are progressing with a focus on application to TV. A demand for technology development addressing such progress is more and more increasing. It is expected for frequency of outdoor use to increase with a focus on application to digital signage or the like in future. There is a demand for development of a liquid crystal display device that can be used even under harsher conditions than in the past and that is capable of realizing high quality image. In view of such needs, it has been pointed out that when the above-described polarizing plate is used under environment of high temperature and high humidity, display unevenness is apt to generate. The display unevenness is thought to be caused by the mechanism in which a stress resulting from shrinkage of the polarizing element under conditions of high temperature and high humidity is introduced into a polarizing plate protective film whereby a change of a phase difference of the polarizing plate protective film occurs near the frame fixing the polarizing plate.

On the other hand, in order to suppress a phase difference unevenness in the width direction and frame-shaped light leakage, a method of adding a high-molecular compound in which N-vinyl-2-pyrolidone is co-polymerized with methyl methacrylate to a cellulose ester film, is proposed (see JP-A-2009-126899 (“JP-A” means unexamined published Japanese patent application).

### SUMMARY OF THE INVENTION

The present invention resides in cellulose acylate film comprising: a cellulose acylate and a polymer, the polymer containing a repeating unit derived from a monomer represented by formula (1):

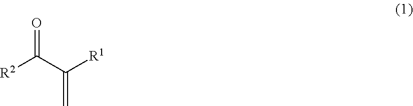

wherein R¹ represents a hydrogen atom or an aliphatic group having 1 to 4 carbon atoms, and R² represents an aliphatic group or an aromatic group.

Further, the present invention resides in a polarizing plate, comprising: a polarizing element and two protective films disposed on both sides of the polarizing element, at least one of the two protective films being made of the cellulose acylate film described above.

Further, the present invention resides in a liquid crystal display device, comprising: a liquid crystal cell and two polarizing plates disposed on both sides of the liquid crystal cell, at least one of the polarizing plates being made of the polarizing plate described above.

Other and further features and advantages of the invention will appear more fully from the following description, appropriately referring to the accompanying drawings.

### BRIEF DESCRIPTION OF THE DRAWING

FIG. 1 is an exploded perspective view schematically showing an example of an internal structure of a liquid crystal display device.

FIG. 2 is a schematic view showing an example of casting to obtain a cellulose acylate film having three-layer structure, by multilayer simultaneous co-casting method using a co-casting die.

### DETAILED DESCRIPTION OF THE INVENTION

The method disclosed in JP-A-2009-126899 is, however, still far from complete satisfaction, in view of the present situation that product development of the liquid crystal display device is further accelerated in order to expand the display size and the application fields. Further, through a study conducted by the present inventors, the points to be solved have been found with respect to the method disclosed in JP-A-2009-126899; the points to be solved are not only unsatisfactory suppression of the frame-shaped light leakage, but also inferiority in quality of transparency. The present invention thus addresses to the provision of a cellulose acylate film having properties of a low photoelastic coefficient, a low water-content ratio, and an excellent transparency.

According to the present invention, there is provided the following means:

(1) A cellulose acylate film comprising:

a cellulose acylate and

a polymer, the polymer containing a repeating unit derived from a monomer represented by formula (1):

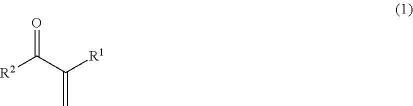

wherein R¹ represents a hydrogen atom or an aliphatic group having 1 to 4 carbon atoms, and R² represents an aliphatic group or an aromatic group.

(2) The cellulose acylate film according to the above item (1), wherein R¹ represents a hydrogen atom, a methyl group, or an ethyl group; and R² represents an aromatic group having 6 to 12 carbon atoms.
(3) The cellulose acylate film according to the above item (1) or (2), wherein R¹ represents a hydrogen atom or a methyl group; and R² represents a methyl group, an ethyl group, a propyl group, a butyl group, or a phenyl group.
(4) The cellulose acylate film according to any one of the above items (1) to (3), wherein the mass-average molecular mass of the polymer comprising a repeating unit derived from a monomer represented by formula (1) is from 500 to 500,000.
(5) The cellulose acylate film according to any one of the above items (1) to (4), wherein the polymer is a homopolymer comprising a repeating unit derived from a monomer represented by formula (1).
(6) The cellulose acylate film according to any one of the above items (1) to (5), wherein the addition amount of the polymer is from 0.1 parts by mass to 300 parts by mass with respect to 100 parts by mass of the cellulose acylate.
(7) The cellulose acylate film according to any one of the above items (1) to (6), wherein the cellulose acylate satisfies an acyl substitution degree of the following mathematical formula:

2.0≦B≦3.0 (B: acyl substitution degree).

(8) The cellulose acylate film according to any one of the above items (1) to (7), wherein the cellulose acylate film has a photoelastic coefficient of 8.0×10⁻¹² Pa⁻¹ or less, a haze of 1% or less, and a water content under the conditions of 80% R.H. and 25° C. of 5% or less.
(9) The cellulose acylate film according to any one of the above items (1) to (8), wherein the cellulose acylate film is obtained by stretching a base film comprising the cellulose acylate and the polymer comprising a repeating unit derived from a monomer represented by formula (1), and the cellulose acylate and the polymer have orientation extending along the stretching direction.
(10) A polarizing plate, comprising:

a polarizing element, and

two protective films disposed on both sides of the polarizing element, at least one of the two protective films being made of the cellulose acylate film according to any one of the above items (1) to (9).

(11) A liquid crystal display device, comprising:

a liquid crystal cell, and

two polarizing plates disposed on both sides of the liquid crystal cell, at least one of the polarizing plates being made of the polarizing plate according to the above item (10).

The cellulose acylate film of the present invention contains cellulose acylate (a) and the following specific polymer (b). Especially, the polymer (hereinafter, referred to as the specific polymer) containing a repeating unit derived from a monomer represented by formula (1), in which a ketone substituent is introduced into a main chain of the polymer by directly binding thereto, has an important role in the present invention. That is, employment of the cellulose acylate film of the present invention as a protective film for polarizing plate makes it possible to achieve reduced photoelastic coefficient, reduced water content ratio and high transparency at the same time at a high level. As for the reason, there are still unexplained points. If allowed by inclusion of presumption, the reason will be given below.

That is, if the specific polymer is manufactured with cellulose acylate into a form of film and the resultant film is stretched, the specific polymer is oriented inside of the film in the drawing direction. Orientation of the polymer molecule may provide a cause on which an optical influence is exerted. If the optical influence becomes remarkable, the film may exhibit optical non-uniformity in the polarizing plate, for example, frame-shaped light leakage, or light unevenness having a circle or ellipse-like shape. The “light unevenness having a circle or ellipse-like shape” is considered to occur in the following manner. Along with the advancement of thinner liquid crystal display devices, there is an increased possibility that a backlight unit come into contact with a polarizing plate disposed at the backlight side of a liquid crystal panel unit. If a liquid crystal display device is used with a backlight unit and a polarizing plate at the backlight side being in contact with each other, for a long period of time or under high temperature and high humidity condition, moisture apt to accumulate at the contact site. The moisture permeates into the polarizing element and causes deterioration of performance of the polarizing plate, resulting in the light unevenness. The “frame-shaped light leakage” is a phenomenon as described in the following. Along with the advancement of the thinner liquid crystal display devices, the distance between a liquid crystal panel unit and a backlight unit become nearer. The heat from the backlight causes strain of optical films and generates a phrase difference at an edge part of the liquid crystal display device, and light leakage at the edge part of screen is observed at black screen display.

In this regard, it is presumed that since the specific polymer is incorporated in the cellulose acylate film of the present invention, the ketone substituent may be disposed so as to be projected from the main chain of the oriented polymer, and plays a role of negating optical anisotropy in the orientation direction. It is also presumed that this makes it possible to reduce the influence of the above-described optical unevenness. Further, it can be considered that the specific polymer does not have a functional group with a particularly high affinity for water in its molecule, and as a result, the specific polymer may be effective in suppressing increase in water content ratio. On the other hand, it is presumed that the specific polymer does not have a structural portion that blocks transmitted light, and as a result, transparency may be secured sufficiently. Hereinafter, the present invention is described in detail on the basis of its preferable embodiment.

### [Specific Polymer]

The cellulose acylate film of the present invention contains a polymer containing a repeating unit derived from a monomer represented by formula (1).

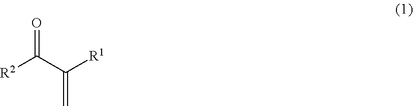

In formula (1), R¹ represents a hydrogen atom or an aliphatic group having 1 to 4 carbon atoms, and R² represents an aliphatic group or an aromatic group.

R¹ is not particularly limited, but preferably a hydrogen atom, a methyl group, or an ethyl group.

R² is not particularly limited. However, as the aliphatic group, an alkyl group, an alkenyl group, an alkynyl group, and a cycloalkyl group are preferable. An alkyl group having 1 to 6 carbon atoms is more preferable. A methyl group, an ethyl group, a propyl group, and a butyl group are still more preferable. A methyl group and a t-butyl group are especially preferable. As the aromatic group, a phenyl group, a naphthyl group, and a biphenyl group are preferable. A phenyl group is especially preferable.

A comonomer component may or may not be present. However, in the case where the specific polymer is a copolymer, it is preferable to use a comonomer having the same skeleton as Formula (1). However, in the comonomer, it is preferable that R² is replaced with the following R^{2a}. That is, R^{2a} is preferably an alkyl group, an alkenyl group, an alkynyl group, a cycloalkyl group, a phenyl group, a naphthyl group, and a biphenyl group. An alkyl group having 1 to 6 carbon atoms or a phenyl group is more preferable. A methyl group, a t-butyl group, and a phenyl group are especially preferable.

In the present invention, the above-described specific polymer is preferably a homopolymer which is composed only of a repeating unit derived from a monomer represented by Formula (1).

An end group of the specific polymer may not be limited. Typically, the end group is a group containing at least any one of a nitrile group, a methyl group and a methyl ester group.

### (Mass-Average Molecular Mass)

The mass-average molecular mass of the specific polymer is preferably from 500 to 500,000, more preferably from 1,000 to 300,000, still more preferably from 1,500 to 200,000, and most preferably from 4,000 to 140,000. When the mass-average molecular mass is above the lower limit, an effect of efficiently reducing photoelastic coefficient of the film can be expected. Meanwhile, when the mass-average molecular mass is below the upper limit, improvement of compatibility with cellulose acylate can be expected. Accordingly the above-described range is preferable.

### (Addition Amount)

The addition amount of the specific polymer is not particularly limited, but preferably from 0.1 parts by mass to 300 parts by mass, more preferably from 1.0 part by mass to 200 parts by mass, and especially preferably from 1.5 parts by mass to 100 parts by mass, with respect to 100 parts by mass of cellulose acylate. When the addition amount is above the lower limit, an effect of efficiently reducing both photoelastic coefficient and water-content ratio of the film can be expected. Meanwhile, when the addition amount is below the upper limit, maintenance of high transparency can be expected. Accordingly the above-described range is preferable.

In the present specification, the term “polymer” or “polymeric substance” is meant to include an oligomer that is a compound having a molecular mass of about 1000 in which, for example, several monomers have been polymerized, in addition to a polymer that is an ordinary high-molecular compound in which a lot of monomers have been polymerized. Further, the term “polymer” or “polymeric substance” is meant, unless otherwise indicated, to include “copolymer” or “copolymeric substance”.

With respect to the expression of group (a group of atoms) used in this specification, the expression even when there is no mention of “substituted or unsubstituted” encompasses groups not only having no substituent but also having a substituent(s). For example, the expression “alkyl group” encompasses not only an alkyl group having no substituent (unsubstituted alkyl group) but also an alkyl group having a substituent(s) (substituted alkyl group). Further, in the present specification, the term “*** compound” is used in the sense of including the compound itself, and in addition thereto, a salt thereof and an ion thereof. Further, the “*** compound” has a meaning of including its derivative, such as a compound substituted with a prescribed substituent or the like, or a partially chemically-modified compound, as long as it exhibits a desired effect.

### <Cellulose Acylate>

Next, the cellulose acylate is explained in detail below.

As the cellulose usable as a raw material of the cellulose acylate for use in the cellulose acylate film in the present invention, use can be made of cotton linter and wood pulp (e.g., broadleaf pulp, and conifer (needleleaf) pulp). Any cellulose acylate obtained from any raw cellulose may be used, and a plurality of celluloses may be used in combination according to the need. There are detailed descriptions of these raw celluloses in, for example, “Plastic Material Lectures (17) Cellulose Resin” (Marusawa and Uda, The Nikkan Kogyo Shimbun, Ltd., published in 1970), and Japan Institute of Invention and Innovation, “Hatsumei Kyokai Kokai Gihou” (Journal of Technical Disclosure) (Kogi No. 2001-1745, Mar. 15, 2001, Japan Institute of Invention and Innovation), pp. 7 to 8; and the raw celluloses described in these publications may be used in the present invention.

One type alone or two or more different types of acyl groups may be used in the cellulose acylate for use in the cellulose acylate film of the present invention. Preferably, the cellulose acylate for use in the cellulose acylate film has an acyl group having 2 to 4 carbon atoms as a substituent. In the case where the cellulose acylate has two or more different types of acyl groups, one of them is preferably an acetyl group, and as the acyl group having 2 to 4 carbon atoms, preferred is a propionyl group or a butyryl group. By employing these cellulose acylates, a solution of good solubility can be produced, and especially in a chlorine-free organic solvent, a good solution can be produced. In addition, a solution having a low viscosity and having good filterability can be produced.

Description will first be made in detail of the cellulose acylate preferably used in the present invention. Each of the glucose units, which constitute cellulose by bonding through β-1,4-glycoside bond, has free hydroxyl groups at the 2-, 3-, and 6-positions thereof. A cellulose acylate is a polymer obtained by esterifying a part or the whole of these hydroxyl groups with an acyl group(s). The “degree of acyl substitution” as referred to herein means the total ratio of acylation of the 2-, 3- and 6-positioned hydroxyl groups in cellulose (100% acylation at each position is represented by a degree of substitution of 1).

The total degree of acyl substitution (B) of the cellulose acylate is preferably 2 to 3 (2.0≦B≦3.0), more of preferably from 2.0 to 2.97, further more preferably from 2.5 to less than 2.97, and even more preferably from 2.70 to 2.95.

It is noted that, in the case where the acylation is acetylation, the above range for the acyl substitution degree should be regarded as ranges for the acetyl substitution degree, and the preferable ranges for the acetyl substitution degree are the same as the ranges described above.

The acyl group having 2 or more carbon atoms in the cellulose acylate may be an aliphatic group or an aromatic group, and are not particularly limited. The cellulose acylate may be an alkylcarbonyl ester of cellulose, an alkenylcarbonyl ester of cellulose, an aromatic carbonyl ester of cellulose or an aromatic alkylcarbonyl ester of cellulose. These esters may further have a substituent. Preferable examples of the acyl group include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group, and a cinnamoyl group. Among these, an acetyl group, a propionyl group, a butanoyl group, a dodecanoyl group, an octadecanoyl group, a tert-butanoyl group, an oleoyl group, a benzoyl group, a naphthylcarbonyl group, and a cinnamoyl group are more preferred; an acetyl group, a propionyl group and a butanoyl group (i.e. the case where the acyl group has from 2 to 4 carbon atoms) are particularly preferred; and the most preferred is an acetyl group (i.e. the case where the cellulose acylate is a cellulose acetate).

In acylation of cellulose, when an acid anhydride or an acid chloride is used as an acylating agent, an organic acid, such as acetic acid, or methylene chloride or the like is used as an organic solvent as a reaction solvent.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose is a method of acylating cellulose with a fatty acid corresponding to an acetyl group or any of other acyl groups (e.g., acetic acid, propionic acid, valeric acid, etc.), or with a mixed organic acid component containing their acid anhydride.

The cellulose acylate can be produced, for example, according to the method described in JP-A-10-45804.

The above-described cellulose acylate film preferably contains from 5% by mass to 99% by mass of cellulose acylate as the above-described resin, from the viewpoint of moisture permeability, more preferably from 20% by mass to 99% by mass, and especially preferably from 50% by mass to 95% by mass.

### <Other Additives>

To the above-described cellulose acylate film, it is possible to add additives, such as a polycondensation polymer, a retardation controlling agent (retardation-developing agent and retardation reducing agent); a plasticizer such as a phthalic acid ester or a phosphoric acid ester; a ultraviolet absorbing agent; an antioxidant; and a matting agent, as an additive other than the above-described polymer or oligomer having the repeating unit derived from a monomer represented by formula (1).

### (Polycondensation Polymer)

From the viewpoint of reduction in haze, it is preferable for the above-described cellulose acylate film to contain a polycondensation polymer.

In the present invention, various high-molecular-mass additives known as additives for cellulose acylate films are widely employable as the polycondensation polymer. The amount of the additive is preferably from 1 to 35 mass %, more preferably from 4 to 30 mass %, even more preferably from 10 to 25 mass % relative to the cellulose resin.

The high molecular mass additive for use in the above-described cellulose acylate film as the polycondensation polymer is a compound having a repeating unit therein, preferably having a number-average molecular mass of from 700 to 10,000. The high molecular mass additive serves to promote the solvent vaporization speed and to reduce the residual solvent amount, in a solution casting process. Further, the high molecular mass additive is effective from the viewpoint of film modification, for example, enhancing the mechanical properties of the film, imparting flexibility and water absorption resistance to the film and reducing the moisture permeability of the film.

The high molecular mass additive for use in the present invention as the polycondensation polymer more preferably has a number-average molecular mass from 700 to 8,000, further preferably from 700 to 5,000, and particularly preferably 1,000 to 5,000.

Description will be made in detail of the high molecular mass additives for use in the present invention as a polycondensation polymer with reference to the specific examples. However, the high molecular mass additives for use in the present invention as the polycondensation polymer are not limited thereto.

Further, the polycondensation polymer is preferably an ester compound of non-phosphoric ester type. In this description, the “ester compound of non-phosphoric ester type” means “a compound that is an ester but is not a phosphoric-ester”.

The high molecular mass additive of the polycondensation polymer includes polyester polymers (aliphatic polyester polymers, aromatic polyester polymers, etc.), and copolymers of a polyester component and any other component. Preferred are aliphatic polyester polymers, aromatic polyester polymers, copolymers of a polyester polymer (aliphatic polyester polymer, aromatic polyester polymer, etc.) and an acrylic polymer; and copolymers of a polyester polymer (aliphatic polyester polymer, aromatic polyester polymer, etc.) and a styrenic polymer; and more preferred are polyester compounds having an aromatic ring as at least one copolymerization component.

The aliphatic polyester polymers is one produced by a reaction of a mixture of an aliphatic dicarboxylic acid having from 2 to 20 carbon atoms, and at least one diol selected from the group consisting of aliphatic diols having from 2 to 12 carbon atoms and alkyl ether diols having from 4 to 20 carbon atoms. Both ends of the reaction product maybe remained as the original product had, or may be blocked by further reaction with monocarboxylic acids, monoalcohols or phenols. The terminal blocking maybe effected for the reason that the absence of a free carboxylic acid is effective for improved storability and the like. The dicarboxylic acid for the polyester polymer for use in the present invention is preferably an aliphatic dicarboxylic acid having from 4 to 20 carbon atoms, or an aromatic dicarboxylic acid having from 8 to 20 carbon atoms.

For the aromatic polyester polymer in this invention, it is preferable to use the above-mentioned polyester in combination with at least one aromatic dicarboxylic acid and at least one aromatic diol, and the combination mode is not specifically defined. Different types of components may be combined in any desired mode. In the present invention, especially preferred is the polymer additive terminated with an alkyl group or an aromatic group, as described above. For the termination, employable is the above-mentioned method.

### (Retardation Reducing Agent)

As the retardation reducing agent, for example, herein widely employable are phosphoric ester compounds and compounds other than non-phosphoric-ester compounds that are known as additives for cellulose acylate films.

The polymer-type retardation reducing agent may be selected from phosphate polyester polymers, styrenic polymers, acrylic polymers, and their copolymers; and acrylic polymers and styrenic polymers are preferred. Preferably, the retardation reducing agent contains at least one kind of polymer having a negative intrinsic birefringence, such as styrenic polymer and acrylic polymer.

Examples of the low-molecular mass retardation reducing agent that is a compound other than non-phosphoric-ester compounds include the following. These may be a solid or an oily substance. In other words, they are not specifically limited in point of the melting point or boiling point thereof. For example, mentioned are a mixture of UV-absorbent materials having a melting point of less than 20° C. and having a melting point of 20° C. or more, as well as a mixture of antiaging agents similarly selected. Further, mentioned are IR absorbent dyes described in, for example, JP-A-2001-194522. The additive may be added in any stage of preparing the cellulose acylate solution (dope); and the additive may be added at the end of the dope preparation process in the final step for additive addition of the process. The amount of the material is not specifically limited so far as the material could exhibit its function.

The low-molecular retardation reducing agent that is a compound other than non-phosphoric-ester compounds is not specifically limited. For example, the compounds are described in detail in JP-A-2007-272177, paragraphs [0066] to [0085].

The compounds represented by formula (1) in JP-A-2007-272177, paragraphs to [0085] may be produced according to the following method.

The compounds of formula (1) in the patent publication can be produced by condensation of a sulfonyl chloride derivative and an amine derivative.

The compounds of formula (2) in JP-A-2007-272177 can be produced by dehydrating condensation of a carboxylic acid and an amine with a condensing agent (e.g., dicyclohexylcarbodiimide (DCC), etc.), or by substitution reaction between a carboxylic acid chloride derivative and an amine derivative.

The retardation reducing agent is preferably an Rth reducing agent from the viewpoint of realizing a favorable Nz factor. Of the retardation reducing agents, examples of the Rth reducing agent include, for example, acrylic polymers, styrenic polymers, and low-molecular-mass compounds of formulae (3) to (7) of JP-A-2007-272177. Of those, preferred are acrylic polymers and styrenic polymers; and more preferred are acrylic polymers.

The retardation reducing agent is added in an amount of preferably from 0.01 to 30% by mass, more preferably from 0.1 to 20% by mass, still more preferably from 0.1 to 10% by mass, with respect to the cellulose resin.

When the retardation reducing agent is added in an amount of at most 30% by mass, compatibility with the cellulose resin can be improved and whitening can be inhibited. When two or more retardation reducing agents are used, the sum amount of the agents is preferably within the above range.

### (Retardation-Developing Agent)

In the above-described cellulose acylate film, at least one retardation-developing agent is preferably added to make the film have a preferable retardation. Not specifically limited, but examples of the retardation-developing agent include rod-shaped compounds, discotic compounds and compounds having retardation developing property among the non-phosphoric ester compounds. Of the rod-shaped or discotic compounds, those having at least two aromatic rings are preferred for use as the retardation-developing agent in the present invention.

The amount of the retardation-developing agent of a rod-shaped compound to be added is preferably from 0.1 to 30 parts by mass relative to 100 parts by mass of the cellulose acylate-containing polymer component, more preferably from 0.5 to 20 parts by mass. Preferably, the amount of a discotic compound contained in the retardation-developing agent is preferably less than 3 parts by mass relative to 100 parts by mass of the cellulose acylate resin, more preferably less than 2 parts by mass, even more preferably less than 1 part by mass.

A discotic compound is superior to a rod-shaped compound in the point of Rth retardation developing properly, and is therefore favorably used in the case where the film requires an especially large Rth retardation. Two or more different types of retardation-developing agents may be combined for use herein.

Preferably, the retardation-developing agent has a maximum absorption in a wavelength region of from 250 to 400 nm, and does not substantially have any absorption in a visible light region.

Details of the retardation-developing agent are described in p. 49, Koukai Gihou 2001-1745.

### (Plasticizer)

Many compounds known as a plasticizer for cellulose acylate may be used for the present invention as the plasticizer. As the plasticizer, a phosphoric acid ester or a carboxylic acid ester can be used. Examples of the phosphoric acid ester include triphenyl phosphate (TPP) and tricresyl phosphate (TCP). Representative examples of the carboxylic acid ester include a phthalic acid ester and a citric acid ester. Examples of the phthalic acid ester include dimethyl phthalate (DMP), diethyl phthalate (DEP), dibutyl phthalate (DBP), dioctyl phthalate (DOP), diphenyl phthalate (DPP), and diethylhexyl phthalate (DEHP). Examples of the citric acid ester include triethyl O-acetylcitrate (OACTE), and tributyl O-acetylcitrate (OACTB). Typical examples of other carboxylic acid ester include butyl oleate, methyl acetyl ricinoleate, dibutyl sebacate, and various trimellitic acid esters. A phthalate-series plasticizer (DMP, DEP, DBP, DOP, DPP, or DEHP) can be preferably used, and DEP and DPP are particularly preferred.

### (Antioxidant)

Any known antioxidant may be added to the cellulose acylate solution in the present invention. For example, phenolic or hydroquinone-based antioxidants may be added, including 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butyl phenol), 2,5-di-tert-butylhydroquinone, pentaerythrityl tetrakis[3-(3,5-di-tert-butyl-4-hydroxyphenyl)propionate], etc. Also preferred are phosphorus-containing antioxidants such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite, bis(2,4-di-tert-butylphenyl)pentaerythritol diphosphite, etc. The amount of the antioxidant to be added may be from 0.05 to 5.0 parts by mass relative to 100 parts by mass of the cellulose resin.

### (UV Absorbent)

From the viewpoint of preventing deterioration of polarizing plates and liquid crystals, a UV absorbent may be added to the cellulose acylate solution in the present invention. Preferably, the UV absorbent has an excellent UV-absorbing capability at a wavelength of 370 nm or less, and has little absorption of visible light having a wavelength of 400 nm or more, from the viewpoint of good liquid crystal display capability. Preferred examples of the UV absorbent for use in the present invention include hindered phenol compounds, hydroxybenzophenone compounds, benzotriazole compounds, salicylic acid ester compounds, benzophenone compounds, cyanoacrylate compounds, nickel complex compounds, etc. Examples of the hindered phenol compounds include 2,6-di-tert-butyl-p-cresol, pentaerythrityl tetrakis[3-(3,5-di-tert-butyl-4-hydroxyphenyl)propionate], N,N′-hexamethylenebis(3,5-di-tert-butyl-4-hydroxy-hydrocinn amide), 1,3,5-trimethyl-2,4,6-tris(3,5-di-tert-butyl-4-hydroxybenzyl)benzene, tris-(3,5-di-tert-butyl-4-hydroxybenzyl)isocyanurate, etc. Examples of the benzotriazole compounds include 2-(2′-hydroxy-5′-methylphenyl)benzotriazole, 2,2-methylenebis(4-(1,1,3,3-tetramethylbutyl)-6-(2H-benzotriazol-2-yl) phenol), (2,4-bis(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinn amide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, 2-(2′-hydroxy-3′,5′-di-tert-amylphenyl)-5-chlorobenzotriazole, 2,6-di-tert-butyl-p-cresol, pentaerythrityl tetrakis[3-(3,5-di-tert-butyl-4-hydroxyphenyl)propionate], etc. The amount of the UV absorbent to be added is preferably from 1 ppm to 1.0%, more preferably from 10 to 1000 ppm in terms of the ratio by mass thereof in the entire optical film.

### (Matting Agent)

Matting agent may be added to the above-described cellulose acylate film from the viewpoint of film slide property and stable manufacture. The matting agent may be a matting agent of an inorganic compound or a matting agent of an organic compound.

Preferred examples of the matting agent of an inorganic compound include silicon-containing inorganic compounds (e.g., silicon dioxide, calcined calcium silicate, hydrated calcium silicate, aluminium silicate, magnesium silicate, etc.), titanium oxide, zinc oxide, aluminium oxide, barium oxide, zirconium oxide, strontium oxide, antimony oxide, tin oxide, antimony-doped tin oxide, calcium carbonate, talc, clay, calcined kaolin, calcium phosphate, etc. More preferred are silicon-containing inorganic compounds and zirconium oxide. Particularly preferred is silicon dioxide since it can reduce the haze of cellulose acylate films. As fine particles of silicon dioxide, for example, commercially available products under such trade names as Aerosil R972, R974, R812, 200, 300, 8202, OX50, TT600 (manufactured by Nippon Aerosil Co., Ltd.) may be used. As fine particles of zirconium oxide, commercially available products, for example, under such trade names as Aerosil R976 and R811 (manufactured by Nippon Aerosil Co., Ltd.) may be used.

Preferred examples of the matting agent of an organic compound include polymers such as silicone resins, fluororesins, acrylic resins, etc. Above all, more preferred are silicone resins. Of silicone resins, even more preferred are those having a three-dimensional network structure. For example, usable are commercial products of Tospearl 103, Tospearl 105, Tospearl 108, Tospearl 120, Tospearl 145, Tospearl 3120 and Tospearl 240 (all trade names by Toshiba Silicone), etc.

When the matting agent is added to a cellulose acylate solution, any method is employable with no problem, as long as it can produce a desired cellulose acylate solution. For example, the additive may be added in the stage where a cellulose acylate is mixed with a solvent; or the additive may be added to a mixture solution prepared from a cellulose acylate and a solvent. Further, the additive may be added to and mixed with a dope just before the dope is cast, and this is a so-called immediate addition method, in which the ingredients may be on-line mixed by screw kneading. Concretely, preferred is a static mixer such as an in-line mixer. As the in-line mixer, for example, preferred is a static mixer SWJ (Toray's static tubular mixer, Hi-Mixer (trade name), by Toray Engineering). Regarding the mode of in-line addition, JP-A-2003-53752 describes an invention of a method for producing a cellulose acylate film wherein, for the purpose of preventing concentration unevenness and particle aggregation, the distance L between the addition nozzle tip through which an additive liquid having a composition differing from that of the main material dope and the start end of an in-line mixer is controlled to be at most 5 times the inner diameter d of the main material feeding line, thereby preventing concentration unevenness and aggregation of matting particles, etc. The patent reference discloses a more preferred embodiment, in which the distance (L) between the nozzle tip opening through which an additive liquid having a composition differing from that of the main material dope and the start end of the in-line mixer is controlled to be at most 10 times the inner diameter (d) of the feeding nozzle tip opening, and the in-line mixer is a static non-stirring tubular mixer or a dynamic stirring tubular mixer. More concretely, the patent reference discloses that the flow ratio of the cellulose acylate film main material dope/in-line additive liquid is from 10/1 to 500/1, more preferably from 50/1 to 200/1. JP-A2003-14933 discloses an invention of providing a retardation film which is free from a trouble of additive bleed out and a trouble of interlayer peeling and which has good lubricity and excellent transparency; and regarding the method of adding additives to the film, the patent reference describes that the additive may be added to a dissolving tank, or the additive or a solution or dispersion of the additive may be added to the dope being fed in the process from the dissolving tank to a co-casting die, further describes that in the latter case, mixing means such as a static mixer is preferably provided for the purpose of enhancing the mixing efficiency therein.

In the above-described cellulose acylate film, the matting agent does not increase the haze of the film so far as a large amount of the agent is not added to the film. In fact, when the film containing a suitable amount of a matting agent is used in LCD, the film hardly brings disadvantages of contrast reduction and bright spot formation. Not too small amount, the matting agent in the film can realize the creaking resistance and the scratch resistance of the film. From these viewpoints, the matting agent content is even more preferably from 0.05 to 1.0% by mass.

### <Configuration and Physical Properties of Cellulose Acylate Film>

### (Layer Structure of Film)

The cellulose acylate film may be a single layer or may be a laminate of two or more layers.

In the case where the cellulose acylate film is a laminate of two or more layers, the film preferably has a two-layered structure or a three-layered structure, more preferably a three-layered structure. The film having a three-layered structure preferably has a layer that is in contact with the metal support when producing the film by solution casting (hereinafter this layer may be also referred to as a support-side surface, or a skin B layer), a layer facing the air interface opposite to the metal support (hereinafter this layer may be also referred to as an air-side surface or a skin A layer), and a core layer (herein after this layer may be also referred to as a base layer) sandwiched between these. Specifically, the film of the present invention preferably has a three-layered structure of skin B layer/core layer/skin A layer.

It is noted that, the skin A layer and the skin B layer would be sometimes collectively called as skin layers (or surface layers).

In the cellulose acylate film, the degree of acyl substitution in the cellulose acylate in the individual layers may be the same; or cellulose acylates having different degree of acyl substitution may be mixed to form one layer. Preferably, the degree of acyl substitution in the cellulose acylate in the individual layers is the same from the viewpoint of regulating the optical properties. When the cellulose acylate film has a three-layer structure, preferably, the cellulose acylates constituting the surface layers on both sides have the same degree of acyl substitution from the viewpoint of reducing the production cost.

### (Photoelastic Coefficient)

The absolute value of photoelastic coefficient of the resin film of the present invention is preferably 8.0×10⁻¹² m²/N or less, more preferably 6×10⁻¹² m²/N or less, and still more preferably 5×10⁻¹² m²/N or less. Reduced photoelastic coefficient of the resin film makes it possible to suppress generation of unevenness under conditions of high temperature and high humidity when the resin film is installed as a polarizing plate-protecting film in a liquid crystal display device. The photoelastic coefficient is measured and calculated in accordance with the method described in Example section below, unless otherwise indicated in particular. The lower limit of photoelastic coefficient is not particularly limited, but practically 0.1×10⁻¹² m²/N or more.

### (Water Content Ratio)

The water content ratio of the resin film can be evaluated by measurement of equilibrium water content ratio at a given temperature and humidity. The equilibrium water content ratio is obtained as follows. That is, a sample is left for 24 hours at the above-described temperature and humidity, and then the water content of the sample which has achieved equilibrium is measured in accordance with Karl Fischer's method, and then the water content (g) is divided with the mass (g) of the sample to calculate the equilibrium water content ratio.

The water content ratio of the resin film of the present invention in terms of percentage at 25° C. and 80% relative humidity (RH) is preferably 5% by mass or less, more preferably 4% by mass or less, and still more preferably less than 3% by mass. Reduced water content ratio of the resin film makes it possible to suppress generation of unevenness under conditions of high temperature and high humidity when the resin film is installed as a polarizing plate-protecting film in a liquid crystal display device. The water content ratio is measured and calculated in accordance with the method described in Example section below, unless otherwise indicated in particular. The lower limit of water content ratio is not particularly limited, but practically 0.1% by mass or more.

### (Haze)

The above-described cellulose acylate film preferably has a haze of 1% or less, more preferably 0.7% or less, further particularly 0.5% or less. Under the condition of haze controlled not more than the above upper limit, the film exhibit higher transparency and better usability as an optical film. The haze is measured and calculated in accordance with the method described in Example section below, unless otherwise indicated in particular. The lower limit of haze is not particularly limited, but practically 0.001% or more.

### (Film Thickness)

Preferably, the mean thickness of the above-described cellulose acylate film is from 30 to 100 μm, more preferably from 30 to 80 μm, even more preferably from 30 to 70 μm. With a mean thickness of at least 30 μm, the handling of the film in producing the film as a web can be improved. With a mean thickness of at most 70 μm, the film may readily follow the ambient humidity change and may keep its optical properties.

In the case where the cellulose acylate film has a three-layer or more multilayer laminate structure, the core layer preferably has a thickness of from 30 to 70 μm, more preferably from 30 to 60 μm. In the case where the film of the present invention has a three-layer or more multilayer laminate structure, the surface layers on both sides (skin A layer and skin B layer) of the film each preferably have a thickness of from 0.5 to 20 μm, more preferably from 0.5 to 10 μm, even more preferably from 0.5 to 3 μm.

### (Film Width)

The film width of the cellulose acylate film is preferably from 700 to 3,000 mm, more preferably from 1,000 to 2,800 mm, particularly preferably from 1,300 to 2,500 mm.

### <Method for Producing Cellulose Acylate Film>

Hereinafter describes the details of the producing method of the cellulose acylate film in the present invention.

The cellulose acylate film is preferably produced in accordance with a solvent-casting method. Examples of production of the cellulose acylate film utilizing a solvent-casting method are given in U.S. Pat. No. 2,336,310, U.S. Pat. No. 2,367,603, U.S. Pat. No. 2,492,078, U.S. Pat. No. 2,492,977, U.S. Pat. No. 2,492,978, U.S. Pat. No. 2,607,704, U.S. Pat. No. 2,739,069, U.S. Pat. No. 2,739,070, British Patent No. 640731, British Patent No. 736892, JP-B-45-4554 (“JP-B” means examined Japanese patent application), JP-B-49-5614, JP-A-60-176834, JP-A-60-203430, JP-A-62-115035, and their descriptions are referred to herein. The cellulose acylate film may be subjected to a drawing treatment. Regarding the method and condition for drawing treatment, for example, referred to are JP-A-62-115035, JP-A-4-152125, JP-A-4-284211, JP-A-4-298310, and JP-A-11-48271.

### (Casting Method)

A solution casting method is employable here, including, for example, a method of uniformly extruding a prepared dope through a pressure die onto a metal support, a doctor blade method where the dope once cast onto a metal support is treated with a blade for controlling its thickness, a reverse roll coater method where the film formation is controlled by the rolls rotating in opposite directions, etc. Preferred is the method using a pressure die. The pressure die includes a coat hunger die, a T-die, etc., any of which is preferably usable here. Apart from the methods mentioned herein, other various methods are also employable that have heretofore been known for film formation by solution casting of cellulose triacetate film. The condition in solution casting may be suitably selected in consideration of the difference in the boiling point or the like of the solvents to be used; and the same effects as in the patent references can also be attained.

### <Co-Casting>

In forming the above-described cellulose acylate film, it is preferable to employ a laminate casting method such as a co-casting method, a successive casting method and a coating method. Above all, it is especially preferable to employ a simultaneous co-casting method from the viewpoint of producing the film stably and reducing the production cost.

In the case of achieving the production by the co-casting method or the successive casting method, first of all, a cellulose acylate solution (dope) for each layer is prepared. The co-casting method (multilayer simultaneous casting) is a casting method in which casting dopes for respective layers (which may be three or more layers) are each extruded on a casting support (for example, a band or a drum) from a casting Gieser, which simultaneously extrudes the dopes from separate slits or the like, thereby casting the respective layers at the same time; followed by stripping off from the support at an appropriate timing and drying to form a film. FIG. 2 is a cross-sectional view showing a state that three layers of dopes 1 for skin layer and a dope 2 for core layer are simultaneously extruded on a casting support 4 by using a co-casting Gieser 3.

The successive casting method is a casting method in which a casting dope for first layer is first extruded and cast on a casting support from a casting Gieser, and after drying or without drying, a casting dope for second layer is then extruded and cast thereon; if desired, a dope is further cast and stack in this manner for third or more layers; and the layers are stripped off from the support at an appropriate timing, followed by drying to form a film. In general, the coating method is a method in which a film for core layer is formed into a film by a solution film formation method; a coating solution for a skin layer is prepared; and the coating solution is coated and dried on the film on every surface one by one or both surfaces at the same time by using an appropriate coating machine to form a film of a laminate structure.

As a metal support that runs in an endless manner, and is used for producing the above-described cellulose acylate film, a drum of which a surface is mirror-finished by chromium plating or a stainless steel belt (the belt may also be called a band) which is mirror-finished by surface polishing is useful. A pressure die to be used may be set up in the number of one or two or more in an upper part of the metal support. The number of pressure dies is preferably one or two. In the case where two or more pressure dies are set up, the amount of the dope to be cast may be divided in various proportions for the respective dies. Also, the dope may be sent to the dies in the respective proportions from plural precision metering gear pumps. The temperature of the dope (resin solution) which is used for casting is preferably from −10° C. to 55° C., and more preferably from 25° C. to 50° C. In that case, the solution temperature may be identical in all of the steps, or the solution temperature may be different in each place of the steps. In the case where the solution temperature is different, it would be better that the solution temperature just before casting is adjusted to a desired temperature.

Moreover, although there is no restriction in particular about the material of the metal support, it is particularly preferable that it is made from SUS (for example, SUS316).

### (Peeling)

The above-described method of producing a cellulose acylate film of the present invention preferably includes a step of peeling away the dope film from the metal support. The method for peeling in the above-described method of producing a cellulose acylate film is not restricted, and known method can be used to improve the peeling aptitude.

### (Stretching Treatment)

The above-described method of producing a cellulose acylate film of the present invention preferably includes a step of stretching (drawing) the formed cellulose acylate film. The stretching direction of the cellulose acylate film may be along the film conveying direction or along the direction perpendicular to the conveying direction (the transverse direction). More preferably, the film is stretched along the direction perpendicular to the film conveying direction (transverse direction), in view of the subsequent process for producing a polarizing plate with using the film.

The stretching method in the width direction is described, for example, in JP-A-62-115035, JP-A-4-152125, JP-A-4-284211, JP-A-4-298310 and JP-A-11-48271. In the case of stretching in the longitudinal direction, for example, the film can be stretched by adjusting the speed of the film conveying roller to make the film take-up speed faster than the film separation speed. In the case of stretching in the transverse direction, the film can be stretched also by conveying the film while keeping the film width by a tenter and gradually increasing the width of the tenter. The film may also be stretched using a stretching machine (preferably uniaxial stretching using a long stretching machine) after drying.

In the case where the above-described cellulose acylate film is used as a protective film of a polarizing element, it is necessary to dispose a transmission axis of the polarizing element in parallel to an in-plane slow axis of the resin film of the present invention, in order to prevent light leakage in viewing a polarizing plate from an inclined direction. Since the transmission axis of a polarizing element continuously produced in a rolled film state is generally parallel to the width direction of the rolled film, in order to continuously stick the polarizing element in a rolled film state and a protective film that is the above-described cellulose acylate film in a rolled film state, it is necessary that the in-plane slow axis of the protective film in a rolled film state is parallel to the width direction of the film. Accordingly, it is preferable that the cellulose acylate film is more stretched in the width direction. Also, the stretching treatment may be achieved on the way of the film formation step, or a raw film having been fabricated and wound up may be subjected to a stretching treatment.

As for the stretching in the transverse direction, stretching of from 5 to 100% is preferable. More preferably the stretching of from 5 to 80% and especially preferably the stretching of from 5 to 40% are conducted. Also, the stretching treatment may be conducted on the way of the film formation step, or alternatively an original (raw) film having been formed and rewound may be subjected to a stretching treatment. In the former case, stretching may be conducted under the conditions of containing a certain amount of a remaining solvent. The stretching can be preferably conducted while containing from 0.05 to 50% of the remaining solvent amount which is defined by the following mathematical formula:

Remaining solvent amount=(Mass of Remaining volatile Component/Mass of Film after heat treatment)×100%

It is especially preferable that the stretching of from 5 to 80% is conducted under the condition of the remaining solvent amount of from 0.05 to 50%.

### (Drying)

The method of producing the above-described cellulose acylate film preferably includes a step of drying the above-described cellulose acylate film and a step of stretching the dried resin film at a temperature not lower than (Tg−10)° C. from the viewpoint of retardation expression.

In general, examples of methods for drying the dope on the metal support in relation to the production of the above-described cellulose acylate film include a method of blowing hot air from the surface side of the metal support (drum or belt), namely from the surface of a web on the metal support; a method of blowing hot air from the back surface of the drum or belt; and a back-surface liquid-heat-conduction method by bringing a temperature-controlled liquid in contact with the back surface of the belt or drum, which is the side opposite to the dope casting surface, and heating the drum or belt by way of heat conduction, to control the surface temperature. Of these methods, the back-surface liquid-heat-conduction method is preferable. The surface temperature of the metal support before casting may be arbitrary set so far as it is not higher than a boiling point of the solvent used in the dope. However, in order to accelerate drying or eliminate fluidity on the metal support, it is preferable that the surface temperature of the metal support is set up at a temperature of from 1° C. to 10° C. lower than a boiling point of the solvent having the lowest boiling point among the solvents used. However, this limitation is not necessarily applied in the case where the casting dope is cooled and peeled off without being dried.

In order to adjust the thickness of the film to a desired value, the concentration of solids contained in the dope, the gap of a slit of a nozzle of the die, the extrusion pressure of the die, the speed of the metal support, etc. may be properly adjusted.

Thus obtained cellulose acylate film is preferably wound up in a length of from 100 to 10,000 m, more preferably from 500 to 7,000 m, and further preferably from 1,000 to 6,000 m, per roll. In winding up, the film is preferably knurled at least in one edge thereof. The width of the knurl is preferably from 3 mm to 50 mm, and more preferably from 5 mm to 30 mm; and the height of the knurl is preferably from 0.5 to 500 μm, and more preferably from 1 to 200 μm. The edge of the film may be knurled on one or both surfaces thereof.

In general, in a large-sized-screen display device, since tinting and lowering of contrast in an inclined direction become remarkable, the above-described cellulose acylate film is especially suitable for use in a large-sized-screen display device. In the case of using the cellulose acylate film as an optical compensation film for large-sized-screen display device, for example, it is preferable that a film is formed in a width of 1,470 mm or more. Also, the polarization plate-protecting film of the present invention includes not only an embodiment of a film piece cut into a size installable into a liquid crystal display device without further cutting operation, but also an embodiment in which the film is prepared in a lengthy form by means of continuous production and wound up in a rolled state. In the polarization plate protecting film of the latter embodiment, the film is stored and conveyed in that state, and the film is cut into a desired size and used at the time of actually installing into a liquid crystal display device or sticking to a polarizing element or the like. Alternatively, the film in a lengthy form is put to a polarizing element composed of a polyvinyl alcohol film or the like as prepared similarly in a lengthy form, and thereafter, the film is cut into a desired size and used when the film is actually installed in a liquid crystal display device. As one of the embodiments of an optical compensation film wound up in a rolled state, an embodiment in which the film is wound up in a rolled state having a roll length of 2,500 m or more is exemplified.

### [Polarizing Plate]

Also, the present invention relates to a polarizing plate having at least one sheet of the polarizing plate-protecting film of the present invention.

The polarizing plate of the present invention preferably comprises a polarizing element and the film of the present invention on one side of the polarizing element. As is the case with the optical compensation film of the present invention, embodiments of the polarizing plate of the invention include not only those in the form of a sheet cut so as to be directly installed into liquid crystal display devices, but also those in the form of a roll as wound up in continuous production (for example, a roll having a roll length of at least 2500 m or at least 3900 m). For application to large-size-screen liquid crystal display devices, the width of the polarizing plate is preferably at least 1470 mm. The concrete configuration of polarizing plate of the present invention is not restricted and known configuration can be adopted, and, for example, the configuration described in FIG. 6 in JP-A-2008-262161 can be adopted.

### [Liquid Crystal Display Device]

The present invention also relates to a liquid-crystal display device that comprises the polarizing plate-protective film of the present invention or the polarizing plate of the present invention.

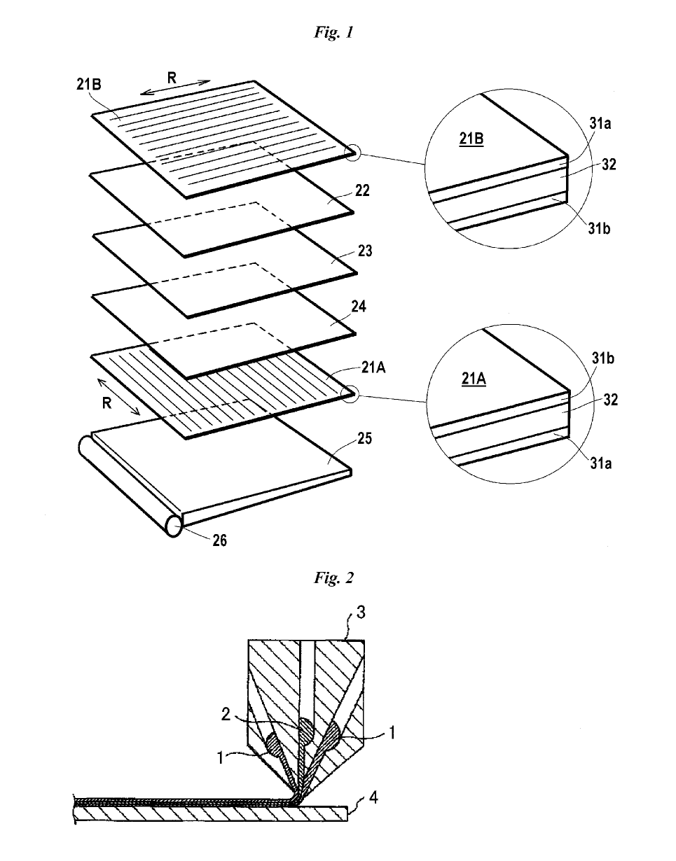

The liquid-crystal display device of the present invention comprises a liquid-crystal cell and a pair of polarizing plates arranged on both sides of the liquid-crystal cell, in which at least one of the polarizing plates is the polarizing plate of the present invention. Preferably, the liquid-crystal display device is a IPS, OCB or VA-mode liquid-crystal display device. An example of an internal configuration of a typical liquid crystal display device is shown in FIG. 1. The concrete configuration of the liquid-crystal display device of the present invention is not specifically defined, for which any known constitution is employable. The configuration described in FIG. 2 in JP-A-2008-262161 is also preferably adapted for the liquid-crystal display device of the invention.

According to the present invention, a cellulose acylate film having a low photoelastic coefficient, a low water-content ratio, and an excellent transparency is provided.

By virtue of its low water-content ratio and reduced photoelastic coefficient, even when the cellulose acylate film of the present invention is under the environment of high temperature and humidity, optical characteristics of the cellulose acylate film are insusceptible to such environment. As a result, installation of the polarizing plate using the cellulose acylate film in a liquid crystal display device allows attaining the liquid crystal display device in which display unevenness does not generate easily, whereby an image display with a stable and good image quality can be realized. Further, by virtue of its excellent transparency, the cellulose acylate film of the present invention prevents reduction in both brightness and contrast which arises from the film, and in addition, enables to realize the above-mentioned good image display.

The present invention will be described in more detail based on examples given below, but the invention is not meant to be limited by these.

### EXAMPLES

### Synthesis Example 1

Into a 300-mL-volume three-neck flask equipped with a stirrer, a thermometer, a reflux condenser, and a nitrogen gas inlet tube, 12.6 g of methyl ethyl ketone was charged, and the temperature was raised to 80° C. A mixed solution containing 21.3 g of methyl isopropenyl ketone, 8.7 g of methyl ethyl ketone and 0.21 g of “V-601” (trade name, produced by Wako Pure Chemical Industries, Ltd.) was added dropwise at a constant rate so that the dropwise addition could be completed in 3 hours. After completion of the dropwise addition, followed by stirring for one hour, (1) a solution containing 0.05 g of “V-601” and 1.0 g of methyl ethyl ketone was added thereto, and the resultant solution was stirred for 2 hours. Subsequently, the step (1) was repeated twice. Further, the resultant solution was stirred for 2 hours and then poured into 1 liter of n-hexane and then the resultant product was dried, thereby obtaining 13.5 g of methyl isopropenyl ketone polymer (A-01). The mass average molecular mass (Mw) of the obtained copolymer was 6,700 (calculated in terms of polystyrene by gel permeation chromatography (GPC); columns used: TSKge1 SuperHZM-H, TSKge1 SuperHZ4000 and TSKgel SuperHZ200 (manufactured by Tosoh Corporation)). Tetrahydrofuran was used as a carrier.

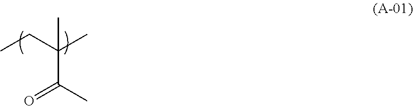

### Synthesis Examples 2 to 8

The following exemplified compounds (A-02) to (A-08) were obtained in the same manner as synthesis of (A-01) in Synthesis Example 1, except that the kind of monomer, the mixing ratio, and the amount of initiator were changed so as to obtain polymers with molar ratio/molecular mass as shown in Table 1. It is noted that, the number accompanying each of the units in (A-06) to (A-08) indicates mass ratio. Hereinafter, the same applies to each chemical formula.

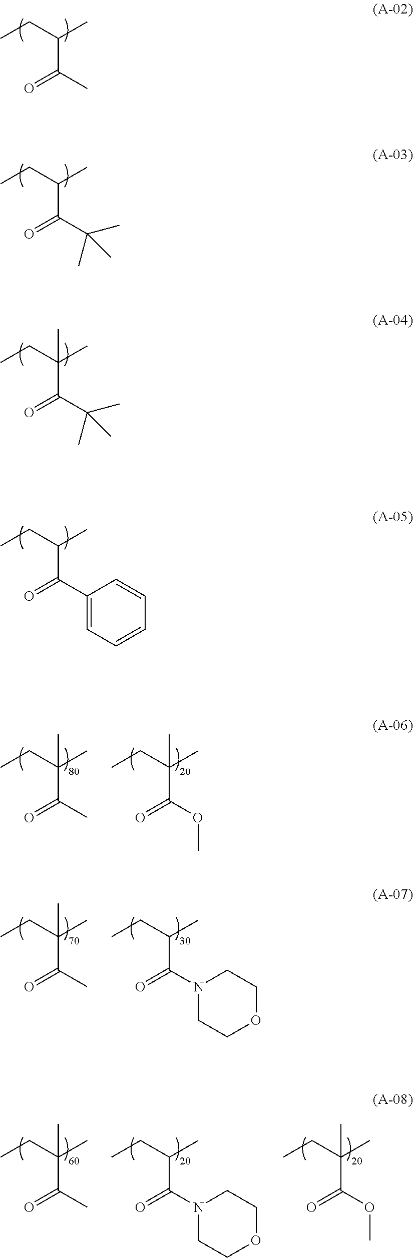

### Comparative Synthesis Example 1

The following exemplified compound (AH-01) was obtained in accordance with the synthetic method described in paragraph [0181] of JP-A-2009-126899.

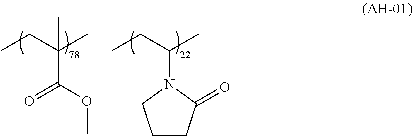

### Comparative Synthesis Example 2

The following exemplified compound (AH-02) was obtained in accordance with the synthetic method described in paragraph [0187] of JP-A-2003-12859.

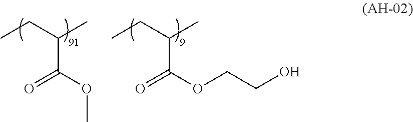

### Example 1 and Comparative Example 1

### (1) Film Formation of Cellulose Acylate Film

### <Preparation of Cellulose Acylate>

A cellulose acylate having acetyl substitution degree of 2.87 was prepared. As a catalyst, sulfuric acid (in an amount of 7.8 parts by mass relative to 100 parts by mass of cellulose) was added, and a carboxylic acid, which serves as a raw material for an acyl substituent, was added for acylation at 40° C. After the acylation, ripening was conducted at 40° C. Further, the low-molecular mass ingredient of the cellulose acylate was removed by washing with acetone.

### <Preparation of Dope 101 Solution for Surface Layer>

### (Preparation of Cellulose Acylate Solution)

The following composition was put into a mixing tank and stirred to dissolve the components to prepare cellulose acylate solution 1.

Composition of cellulose acylate solution 1

| | |
|---|---|
| Cellulose acetate having acetyl substitution degree | 100.0 mass parts |
| of 2.87 and polymerization degree of 370 | |
| Triphenyl phosphate | 8.0 mass parts |
| Phenyl biphenyl phosphate | 4.0 mass parts |
| Methylene dichloride (first solvent) | 353.9 mass parts |
| Methanol (second solvent) | 89.6 mass parts |
| n-Butanol (third solvent) | 4.5 mass parts |

### (Preparation of Matting Agent Solution 2)

The following composition was put into a disperser and dispersed to prepare a mat agent solution 2.

Composition of matting agent solution 2

| | |
|---|---|
| Silica particles having a mean particle size 20 nm | 2.0 mass parts |
| (trade name: AEROSIL R972, manufactured by | |
| Nihon Aerosil Co., Ltd.) | |
| Methylene dichloride (first solvent) | 69.3 mass parts |
| Methanol (second solvent) | 17.5 mass parts |
| n-Butanol (third solvent) | 0.9 mass part |
| Cellulose acylate solution 1 described above | 0.9 mass part |

### (Preparation of UV Absorbent Solution 3)

The following composition was poured in a mixing tank and stirred while heating to dissolve each component, thereby preparing the UV absorbent solution 3.

Composition of UV absorbent solution 3

| | |
|---|---|
| UV Absorbent C described below | 20.0 mass parts |
| Methylene dichloride (first solvent) | 61.0 mass parts |
| Methanol (second solvent) | 15.4 mass parts |
| n-Butanol (third solvent) | 0.8 mass part |
| Cellulose acylate solution 1 described above | 12.8 mass parts |

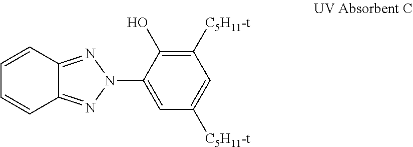

Each of 1.3 parts by mass of the above-described matting agent solution 2 and 3.4 parts by mass of the UV absorbent solution 3 was filtrated, and then these solutions were mixed using an inline mixer. Further, 95.3 parts by mass of the cellulose acylate solution 1 was added thereto, and these solutions were mixed using an inline mixer, thereby preparing the solution 101 for skin layer.

### <Preparation of Dope 101 for Core Layer>

### (Preparation of Cellulose Acylate Solution)

The following composition was poured into a mixing tank and stirred to dissolve each component, thereby preparing the Dope 101 for core layer.

Composition of cellulose acylate solution 2

| | |
|---|---|
| Cellulose acetate having acetyl substitution degree | 100.0 mass parts |
| of 2.87 and polymerization degree of 370 | |
| Polymer (A-01) | 43.0 mass parts |
| UV Absorbent C described above | 2.0 mass parts |
| Methylene dichloride (first solvent) | 297.7 mass parts |
| Methanol (second solvent) | 75.4 mass parts |
| n-Butanol (third solvent) | 3.8 mass parts |

### <Casting>

The dope (dope for core layer) prepared as described above and the dope for skin layer to be disposed on both sides of the dope for core layer were uniformly cast from a casting opening onto a stainless casting support (support temperature: −9° C.) so that three layers consisting of the core layer and both skin layers were formed thereon at the same time, using a drum caster. The resultant film was peeled from the support in the state that the amount of a remaining solvent in the dope of each layer was about 70% by mass, and then both ends in the width direction of the film were fixed with a pin tenter, and then the film was dried while stretching it 1.28 times in a transverse direction in the state that the amount of a remaining solvent was from 3 to 5% by mass. After that, the film was further dried by conveying it between rolls of a thermal treatment apparatus, thereby obtaining the cellulose acylate film 101 according to the present invention. The thickness and the width of the obtained cellulose acylate film 101 were 60 μm and 1480 mm respectively.

The polarizing plate-protecting films of Examples 102 to 110 and Comparative Examples c11 to c15 were produced in the same manner as the above-described film 101, except that polymer (A-01) was replaced with compounds, the kind and the addition amount of which were as shown in Table 1. The evaluation results of each film in terms of the following items are shown in Table 1.

### [Evaluation]

### (Determination of Photoelastic Coefficient)

The photoelastic coefficient was determined by preparing a film cut out into a size of 3.5 cm×12 cm and measuring Re without a load or under a load of 250 g, 500 g, 1,000 g or 1,500 g with an ellipso-meter (M150, manufactured by JASCO Corporation), and by calculating from the gradient of a straight line of the Re change with respect to the stress. The results evaluated in accordance with the following criteria are shown in Table 1.

Excellent: less than 6×10⁻¹² Pa⁻¹

Good: from 6.0×10⁻¹² to 8.0×10⁻¹² Pa⁻¹

Poor: more than 8.0×10⁻¹² Pa⁻¹

### (Measurement of Water Content Ratio)

After humidity conditioning under the environment of 25° C. and 80% RH for 24 hours, the equilibrium water content ratio was measured using Karl Fischer water-content measuring equipment AQ-2000 (trade name) manufactured by Hiranuma Sangyo Corporation. The results evaluated in accordance with the following criteria are shown in Table 1.

Excellent: Water content ratio was less than 3%.

Good: Water content ratio was from 3% to 5%.

Poor: Water content ratio was more than 5%.

### (Measurement of Haze)

The haze was measured by using a film sample of 40 mm×80 mm at 25° C. and 60% RH with the use of a haze meter “HGM-2DP” (trade name, manufactured by Suga Shikenki Co., Ltd.), in accordance with JIS K-6714. The results evaluated in accordance with the following criteria are shown in Table 1.

Excellent: Haze was 1% or less.

Fair: Haze was more than 1% and 3% or less.

Poor: Haze was more than 3%.

TABLE 1

| | Specific Polymer | | | | | | |
|---|---|---|---|---|---|---|---|
| | | Mass- | | Evaluation | | | |
| | | average | Amount in | | Water | | |
| Film | | molecular | the base | Photoelastic | content | | |
| # | Kind | mass | layer^{a)} | coefficient | ratio | Haze | Remarks |
| 101 | A-01 | 6,700 | 43 | Excellent | Excellent | Excellent | This invention |
| 102 | A-02 | 138,000 | 43 | Good | Excellent | Excellent | This invention |
| 103 | A-03 | 4,000 | 43 | Good | Excellent | Excellent | This invention |
| 104 | A-04 | 12,000 | 20 | Good | Excellent | Excellent | This invention |
| 105 | A-05 | 5,500 | 150 | Good | Excellent | Fair | This invention |
| 106 | A-06 | 7,700 | 25 | Good | Excellent | Excellent | This invention |
| 107 | A-07 | 8,000 | 50 | Good | Good | Excellent | This invention |
| 108 | A-8 | 6,000 | 30 | Good | Excellent | Excellent | This invention |
| 109 | A-04 | 12,000 | 0.05 | Good | Good | Excellent | This invention |
| 110 | A-8 | 6,000 | 400 | Excellent | Excellent | Fair | This invention |
| c11 | None | — | — | Poor | Poor | Excellent | Comparative example |
| c12 | AH-01 | 10,000 | 43 | Poor | Poor | Poor | Comparative example |
| c13 | AH-02 | 5,000 | 43 | Poor | Poor | Poor | Comparative example |
| c14 | PVPK-30^{b)} | 40,000 | 43 | Good | Poor | Poor | Comparative example |
| c15 | DIANAL BR83^{c)} | 40,000 | 43 | Poor | Excellent | Poor | Comparative example |

^{a)}The addition amount (mass parts) to 100 mass parts of cellulose acylate
^{b)}manufactured by NIPPON SHOKUBAI CO., LTD.
^{c)}manufactured by MITSUBISHI RAYON CO., LTD.

From the results shown in the above Table 1, it is seen that resin films of the present inventions (Examples) containing a polymer having a repeating unit derived from a monomer represented by Formula (1) are favorable in that both photoelastic coefficient and water content ratio are small and haze is low.

The film c11 of Comparative Example is an embodiment in which the polymer according to the present invention is not used, and c11 was inferior to the films of the present invention in terms of both photoelastic coefficient and water content ratio.

The films c12-c15 of Comparative Examples are embodiments in which the copolymers used in Examples of JP-A-2009-126899 or JP-A-2003-12859 are used, or the polymers shown in Table 1 are used. However, each of these films was inferior to the films of the present invention in terms of the above-described properties.

### Example 2 and Comparative Example 2

### (2) Preparation of Polarizing Plate

### {Saponification Treatment of Protective Film of Polarizing Plate}

The polarizing-plate protective film produced in Example 1 was dipped in a 2.3 mol/L aqueous solution of sodium hydroxide at 55° C. for 3 minutes. Next, the film was washed in a water washing bath at room temperature and then neutralized with 0.05 mol/L sulfuric acid at 30° C. Next, it was washed again in a water washing bath at room temperature and dried in a hot air stream at 100° C. Thus, the surface of the polarizing-plate protective film of Example 1 was saponified.

### {Preparation of Polarizing Plate}

Iodine was adsorbed by a stretched polyvinyl alcohol film to prepare a polarizing element.

The saponified polarizing-plate protective film 101 of Example 1 was stuck to one surface of the polarizing element, using a polyvinyl alcohol adhesive. A commercial cellulose triacetate film (trade name: Fujitac TD80UF, by manufactured by FUJIFILM Corporation) was saponified in the same method, and the saponified cellulose triacetate film was stuck to the polarizing element, using a polyvinyl alcohol adhesive, at the side of the polarizing element opposite to the side where the polarizing plate protective film of Example 1 was stuck.

In the above, the films were so stuck to the polarizing element that the transmission axis of the polarizing element could be perpendicular to the slow axis of the polarizing-plate protective film produced in Example 1, and that the transmission axis of the polarizing element could be perpendicular to the slow axis of the commercial cellulose triacetate film.

Thus, the polarizing plate 201 of this invention was prepared.

With using the polarizing-plate protective films 102 to 110 (this invention) and c11 to c15 (comparative example), saponification and preparation of polarizing plates were conducted in the same manner as described above, to produce polarizing plates 202 to 210 (this invention) and c21 to c25 (comparative example).

### Example 3 and Comparative Example 3

### Manufacture of Liquid Crystal Display Device

The polarizing plate of a commercially-available liquid crystal television set (BRAVIA J5000, manufactured by Sony Corporation) at the side of viewer was peeled, and the polarizing plate 201 of the present invention using the polarizing plate-protecting film 101 of Example 1 was put with an adhesive so that the polarizing plate-protecting film 101 was disposed at the side of the liquid crystal cell (film 31b in FIG. 1). The transmission axis of the polarizing plate at the side of viewer was vertically disposed. This situation is as illustrated in the schematic view of FIG. 1. The thus-produced liquid crystal display device was equipped with, in the following order from the underside of the drawing, light source 26, light guide plate 25, a first polarizing plate 21A (polarizing element 32, polarizing films 31a and 31b), array substrate 24 having an oriented film and a transparent electrode, liquid crystal layer 23, color filter substrate 22 having an oriented film and a transparent electrode, and polarizing plate 21B. As described above, the protective film 31b of the second polarizing plate 21B was exchanged to films of the Examples of the present invention or Comparative Examples. In this time, the protective film was disposed so that the drawing direction of the protective film and the polarizing direction R of the polarizing plate would coincide each other.

Further, liquid crystal display devices 302 to 310 of Examples and liquid crystal display devices c31 to c35 of Comparative Examples were produced in the same manner as the above-described liquid crystal display device, except that protecting films and polarizing plates of other Examples and polarizing plate-protecting films and polarizing plates of Comparative Examples were used.

The thus-produced liquid crystal display devices were left for 24 hours under the environment of 60° C. and 90% RH, and then display unevenness was checked. As a result, the liquid crystal display devices of the present invention were favorable in the point that the unevenness was not generated or the area of the generated unevenness was less than the liquid crystal display devices using each of the polarizing plate-protective films of Comparative Examples.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2011-087571 filed in Japan on Apr. 11, 2011 and Patent Application No. 2012-088762 filed in Japan on Apr. 9, 2012, each of which is entirely herein incorporated by reference.

What is claimed is:

1. A cellulose acylate film comprising:
a cellulose acylate and
a polymer, the polymer containing a repeating unit derived from a monomer represented by formula (1): 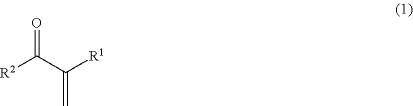
wherein R¹ represents a hydrogen atom or an aliphatic group having 1 to 4 carbon atoms, and R² represents an aliphatic group or an aromatic group.

2. The cellulose acylate film according to claim 1, wherein R¹ represents a hydrogen atom, a methyl group, or an ethyl group; and R² represents an aromatic group having 6 to 12 carbon atoms.

3. The cellulose acylate film according to claim 1, wherein R¹ represents a hydrogen atom or a methyl group; and R² represents a methyl group, an ethyl group, a propyl group, a butyl group, or a phenyl group.

4. The cellulose acylate film according to claim 1, wherein the mass-average molecular mass of the polymer comprising the repeating unit derived from the monomer represented by formula (1) is from 500 to 500,000.

5. The cellulose acylate film according to claim 1, wherein the polymer is a homopolymer comprising a repeating unit derived from the monomer represented by formula (1).

6. The cellulose acylate film according to claim 1, wherein the addition amount of the polymer is from 0.1 parts by mass to 300 parts by mass with respect to 100 parts by mass of the cellulose acylate.

7. The cellulose acylate film according to claim 1, wherein the cellulose acylate satisfies the acyl substitution degree of the following mathematical formula:
2.0≦B≦3.0 (B: acyl substitution degree).

8. The cellulose acylate film according to claim 1, wherein the cellulose acylate film has a photoelastic coefficient of 8.0×10⁻¹² Pa⁻¹ or less, and a haze of 1% or less, and a water content under the conditions of 80% R.H. and 25° C. of 5% or less.

9. The cellulose acylate film according to claim 1, wherein the cellulose acylate film is obtained by stretching a base film comprising the cellulose acylate and the polymer comprising the repeating unit derived from the monomer represented by formula (1), and the cellulose acylate and the polymer have orientation extending along the stretching direction.

10. A polarizing plate, comprising:
a polarizing element; and
two protective films disposed on both sides of the polarizing element, at least one of the two protective films being made of the cellulose acylate film according to claim 1.

11. A liquid crystal display device, comprising:
a liquid crystal cell, and
two polarizing plates disposed on both sides of the liquid crystal cell, at least one of the polarizing plates being made of the polarizing plate according to claim 10.
